(19) United States
(12) Patent Application Publication
(10) Pub. No.: US 2002/0150121 A1
(43) Pub. Date: Oct. 17, 2002

(54) Packet switching device for multi-stage networks with distributed switching and a bufferless switching matrix

(76) Inventors: Andries Van Wageningen, Wijlre (NL); Hans-Jurgen Reumermann, Aachen (DE); Armand Lelkens, Klimmen (NL)

Correspondence Address: U.S. Philips Corporation, 580 White Plains Road, Tarrytown, NY, 10591, US

(21) Appl. No.: 10/117,611

(22) Filed: Apr. 5, 2002

(30) Foreign Application Priority Data
Apr. 10, 2001 (DE) 10117788.7

(51) Int. Cl. H04J 3/02

(52) U.S. Cl. 370/462; 370/412

(57) ABSTRACT

The invention relates to a packet switching device comprising a switching network consisting of a plurality of bufferless switching matrices and switching controllers connected to form a network and each associated with a switching matrix, the output of a switching controller being in each case connected with all the inputs of all parallel-connected switching controllers arranged in the following row.

The invention relates to a packet switching device with a switching network.

In the publication “Weighted Arbitration Algorithms with Priorities for Input-Queued Switches with 100% Throughput” by R. Schoenen, G. Post, G. Sander, Broadband Switching Symposium '99, different, weighted switching algorithms of a packet switching device are compared. The switching algorithms attempt, with different switching stages, to prevent a collision between a plurality of packets destined for the same output port of the packet switching device and to reduce data loss or delay resulting therefrom.

It is an object of the invention to ensure collision-free switching of data in packet form.

Said object is achieved by a packet switching device comprising a switching network consisting of a plurality of bufferless switching matrices and switching controllers connected to form a network and each associated with a switching matrix, which switching controllers each comprise at least

one identifier analyzer for identifying an input port in a route identifier associated with a packet and for storing connections already granted between input ports and output ports,

one output arbiter for evaluating inquiries sent with a route identifier,

one identifier grant analyzer for analyzing the identifiers of the inquiries granted by the output arbiter,

one input arbiter for evaluating granted inquiries with identifiers, and

one result analyzer for informing the identifier analyzer about accepted connections,

the output of a switching controller being in each case connected to all the inputs of all parallel-connected switching controllers arranged in the following row.

A packet switching device switches the signaling data and payload data received in packet form at the input port to the appropriate output port.

During generation of a route identifier for controlling the packet by the packet switching device, a port controller responsible for the input port makes use of a table containing the routing and priority information necessary for the route identifier. The routing and priority information indicate the destination output of the packet switching device and a weighting of the inquiry. Weighting may include details of the priority and category of the packets or the queuing time or length of a queue.

The packet switching device consists of a plurality of bufferless switching matrices for connecting input ports and output ports and a plurality of switching controllers for initializing and changing the configuration of the switching matrices and a number of registers in the form of logical queues operating according to the FIFO (First In First Out) principle.

The interface between the port controller and the packet switching device may either consist of two separate lines for signaling data and payload data or part of the port controller is integrated with the packet switching device and the signaling data and payload data are jointly transmitted in multiplexed manner via one line (“in-band control”).

If a bufferless switching matrix is used, a collision between a plurality of packets destined for the same output port leads to packet loss. In order to prevent this loss, the packets are stored temporarily in queues within the port controller. Since cells of uniform length are easier to handle during switching than packets of varying size, the packets arriving at the port controller are divided into cells of uniform length. After successful switching, i.e. accepted allocation of an input port with an output port, has been performed, the cells are removed from the queue.

A cell may either be sent to the packet switching device at the same time as the route identifier or the cell is conveyed separately to the packet switching device once the route identifier has arrived with an inquiry some time previously at the packet switching device and the latter has carried out its preparations for transfer of the cell.

Simultaneous forwarding of route identifier and cell is known as “self-routing”. It has the disadvantage that the decision is made in the port controller as to which cell is switched and collision of the cells cannot be prevented thereby. Separate forwarding of the route identifier and the cell cannot substantially reduce loss caused by cell collision.

Another option is to send the route identifier to the packet switching device with a plurality of inquiries, the latter deciding which of the inquiries is accepted in order then to carry out preparations for transfer of the selected cell. This option offers virtually loss-free cell switching.

To increase the capacity of the packet switching device, a plurality of switching matrices are operated in parallel and connected together to form a network. The switching matrices are each controlled individually by a switching controller. To configure the switching matrices, an algorithm distributed over the switching controllers is used to enable the packet switching device to make a global decision.

On the basis of the weighting of an inquiry, one switching controller input is allocated to each output in each switching controller. In the route identifier, this result serves at the output of each switching controller as an inquiry for the switching controllers arranged in parallel as the next stage.

In the event that the route identifier arriving at the switching controller from each input port contains a plurality of inquiries (in one cell period) for different output ports, a two-fold switching algorithm is used in switching. One switching algorithm is used to select an inquiry from all the input ports for each output port and the second switching algorithm is used to specify the granted inquiry of an output port for each input port.

At the output of each last stage switching controller there is applied a first part of the switching decision. Feedback of the first part of the switching decision is designed to take place over the same path in the reverse direction. During feedback too, one switching controller input is allocated to each output in each switching controller, on the basis of the weighting of an inquiry. At the input of each last stage switching controller there is applied a second part of the switching decision. The switching decision is retained for connection of the inputs and outputs. By iteration of this switching via as yet unallocated inputs, the switching decision may be improved.

Since collision of the route identifiers may occur on the path from the input of the first switching controller to the output of the last switching controller, the result of the first part of the switching decision must be fed back in the opposite direction on the same path, so that no further path recognition processes are necessary. Therefore, both the input port number and the output port number are cited in the route identifier.

The invention will be further described with reference to examples of embodiment shown in the drawings to which, however, the invention is not restricted. In the Figures:

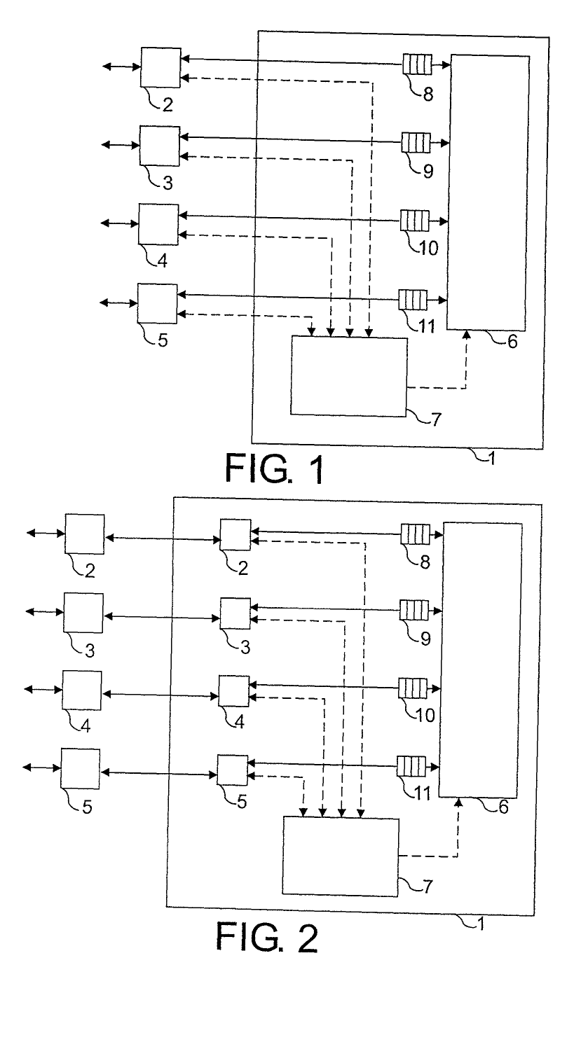

FIG. 1 is a representation of a packet switching device with separate inputs for signaling data and payload data,

FIG. 2 is a representation of a packet switching device with inputs for jointly multiplexed signaling data and payload data (“in-band control”),

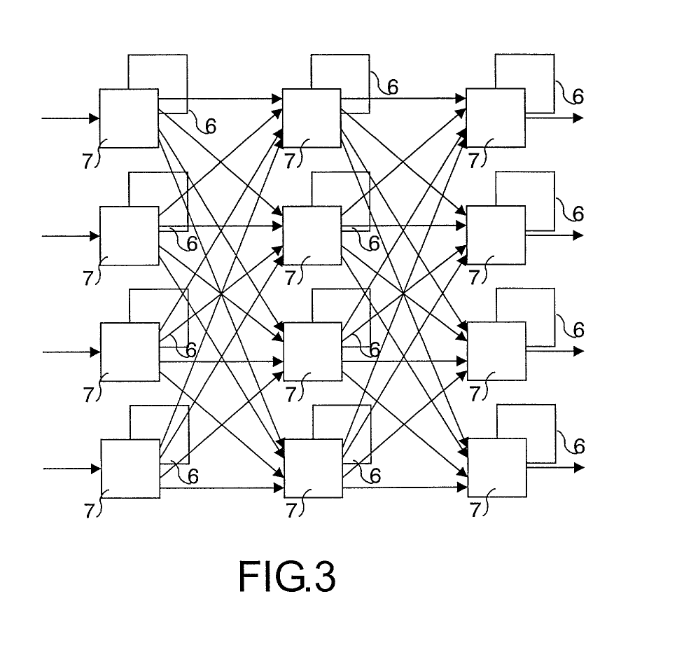

FIG. 3 shows switching matrices with a plurality of switching controllers connected to form a network,

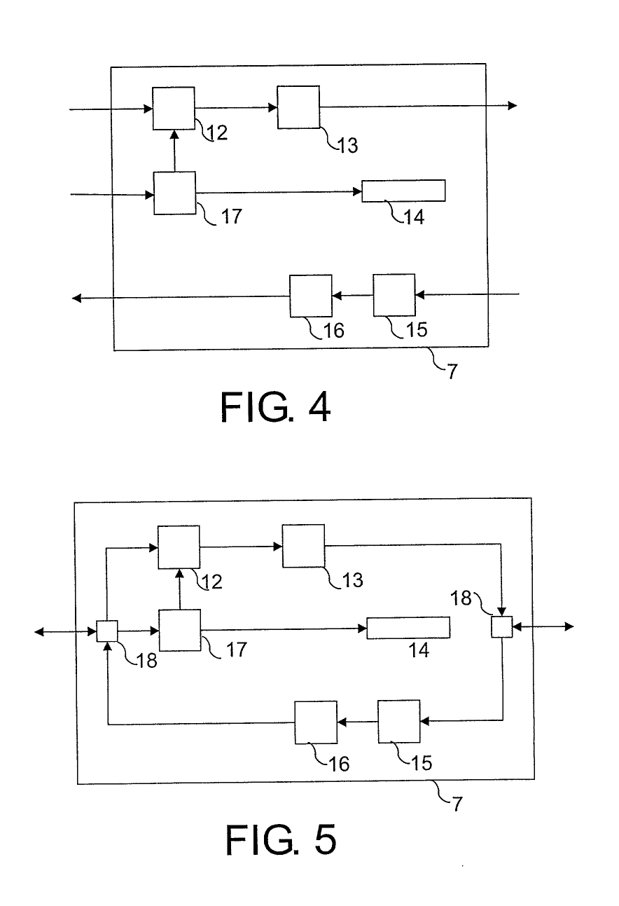

FIG. 4 is a diagram showing the principle of the method of operation of a switching controller

FIG. 5 is a diagram showing the principle of the method of operation of a switching controller.

The packet switching device 1 shown in FIG. 1 for packet data transport connects a given number of input ports with the corresponding output ports. Information, such as for example a route and priority level, is determined for the packets arriving at the input port in each case by a port controller 2 to 5 by means of switching tables. Once the packets have been divided into cells, the latter are conveyed to the previously determined output line of the packet switching device 1. The switching steps provided for further switching are explained below.

The packet switching device 1 consists of a switching matrix 6, a switching controller 7 and a number of registers 8 to 11 in the form of logical queues operating according to the FIFO (First In First Out) principle.

An alternative representation of the packet switching device 1 is described in more detail with reference to FIG. 2. In contrast to the packet switching device 1 shown in FIG. 1, the port controller 2 to 5 is subdivided into two parts, wherein one part of the port controller 2 to 5 is in each case integrated with the packet switching device (for “in-band control”). As a result, no separate signaling data and payload data connections are provided at the interface between the first part of the port controller 2 to 5 and the packet switching device 1, but rather just one connection, via which the signaling data and payload data are multiplexed and transmitted jointly to the packet switching device 1.

In order to forward cells, the port controller 2 to 5 generates a route identifier with information relating to the input and destination output of the packet switching device and weighting of the inquiry. The weighting may include details of the priority and category of the packets or the queuing time or length of any queue.

Operation of the packet switching device in the event of joint forwarding of the route identifier and the cell is described below. The port controller 2 to 5 conveys the cell to the packet switching device 1 at the same time as the route identifier. Inside the packet switching device, the route identifier is forwarded to the switching controller 7 and the associated cell to the switching matrix, where it is inserted into a register 8 to 11 operating according to the FIFO (First In First Out) principle.

By networking the switching controllers as shown in FIG. 3, better switching device performance parameters, such as delay to the packets caused by switching and length of queues, may be achieved. In this example, in each case three switching controllers are connected in series and in each case four are operated in parallel, such that the network illustrated in FIG. 3 is produced with the corresponding connections. The output of each switching controller 7 is in each case connected to each input of the switching controllers 7 located in the following column.

In this way, the result of switching the first switching controller 7 in a row is distributed over all the switching controllers 7 located in the following column and serves as an interrogating route identifier in the following switching controllers 7. The first part of the switching decision is fixed at the output of the switching devices 7 located in the last column. The first part of the switching decision is fed back, so that the second part of the switching decision may be produced in similar manner in the reverse direction. A final iteration result is fixed by the switching controllers arranged in the first column of the network and forwarded to the port controller 2 to 5. So that the final result is retained in the switching controllers, it has to be sent once again to the switching controller network.

Operation of the packet switching device 1 illustrated in FIGS. 1 to 3 is explained in more detail with reference to the diagrams shown in FIGS. 4 to 5.

The switching controller 7 illustrated in FIG. 3 contains an identifier analyzer 12, an output arbiter 13, a configuration unit 14 and a result analyzer 17 as components necessary for the forward direction, together with an identifier grant analyzer 15 and an input arbiter 16 for the backward direction.

The port controller 2 to 5 generates the route identifier, which contains all the destination output numbers of the packet switching device, a plurality of inquiries and the associated weightings. The route identifier is forwarded to the switching controller 7, wherein the cells remain in the port controller 2 to 5 and are switched at a later time.

The identifier analyzer 12 stores the route identifier signal, amplified by a refresher 21, inside the switching controller 7, for use at a later point for performing iterative switching steps.

The following switching steps are repeated iteratively.

The inquiries processed in the previously performed iterative switching steps, i.e. the connections already granted between the input ports and the output ports of the packet switching device, are stored by the identifier analyzer 12. The route identifier for all unswitched inputs is forwarded to the competent output arbiter 13.

A separate output arbiter 13 is responsible for each output port and processes all the inquiries coming from the identifier analyzer 12. On the basis of the route identifier weighting, the output arbiter 13 decides which of the inquiries will be accepted. The selected route identifier is forwarded to the switching controller of the next stage of the network.

At the output of the last switching controller 7 arranged in the last stage, the route identifier is fed back and transmitted to the identifier grant analyzer 15.

The identifier grant analyzer 15 passes the route identifier on to the competent input arbiter 16.

One input arbiter 16 is responsible for each input port and processes the result for the corresponding input port coming from the identifier analyzer 15. On the basis of the route identifier weighting, the input arbiter 16 decides which of the allocations will be accepted. The selected result is passed on to the switching controller 7 in the previous stage of the network.

In the first stage switching controller 7, the result is passed on to the result analyzer 17 and the configuration unit 14, then forwarded to the port controller 2 to 5 and transmitted to the next stage switching controller 7, such that all the relevant switching controllers 7 are informed of the result.

The result analyzer 17 informs the identifier analyzer 12 of the accepted results.

The granted route identifiers of the result analyzer 17 are collected in the configuration unit 14, before the configuration unit 14 sends them to the configuration registers of the switching matrix 6. In the next step, the switching device 1 is appropriately reconfigured for transmission of the cells.

Once the interrogating port controller 2 to 5 has received the modified route identifier, the cells are only then sent to the switching matrix 6 and subsequently removed from the queue.

Since the input and output port numbers are contained as information in the route identifier, this information may be used in path recognition and the route identifier may be sent back within the same path to the appropriate port controller. In order to reduce the number of pins serving as physical in- and outputs, bidirectional in- and outputs are used in the example of embodiment according to the invention of the switching controller 7. The embodiment illustrated in FIG. 5 correspond in content and function to the example illustrated in FIG. 4 and differs soley in the addition of two bidirectional in- and outputs 18.

1. A packet switching device comprising a switching network consisting of a plurality of bufferless switching matrices (6) and switching controllers (7) connected to form a network and each associated with a switching matrix (6), which switching controllers (7) each comprise at least
one identifier analyzer (12) for identifying an input port in a route identifier associated with a packet and for storing connections already granted between input ports and output ports,
one output arbiter (13) for evaluating inquiries sent with a route identifier,
one identifier grant analyzer (15) for analyzing the identifiers of the inquiries granted by the output arbiter,
one input arbiter (16) for evaluating granted inquiries with identifiers, and
one result analyzer (17) for informing the identifier analyzer (12) about accepted connections,
the output of a switching controller (7) being in each case connected to all the inputs of all parallel-connected switching controllers (7) arranged in the following row.

2. A packet switching device as claimed in claim 1, characterized in that the route identifier is fed back to a port controller (2 to 5) responsible for generating the route identifier through all the switching controllers (7) previously passed through.

3. A packet switching device as claimed in claim 1, characterized in that the route identifier contains routing and priority information.

4. A packet switching device as claimed in claim 1, characterized in that the switching controllers (7) have available bidirectional in- and outputs.

5. A packet switching device as claimed in claim 1, characterized in that the matrix switch is connected with a plurality of input ports via multiplexed signaling data and payload data connections.
